(19) United States
(12) Patent Application Publication
(10) Pub. No.: US 2022/0312055 A1
(43) Pub. Date: Sep. 29, 2022

(54) METHOD AND APPARATUS OF EXTRACTING HOT CLIP IN VIDEO

(71) Applicant: Beijing Baidu Netcom Science and Technology Co., Ltd., Beijing (CN)

(72) Inventor: Qian ZHANG, Beijing (CN)

(21) Appl. No.: 17/419,230

(22) PCT Filed: Dec. 1, 2020
(86) PCT No.: PCT/CN2020/133034

§ 371 Date: Jun. 28, 2021

(30) Foreign Application Priority Data
Feb. 21, 2020 (CN) 202010108683.8

(51) Int. Cl. H04N 21/234; H04N 21/442; H04N 21/2343; H04N 21/845; G06V 20/40

(52) U.S. Cl. CPC H04N 21/23418; H04N 21/44222; H04N 21/234381; H04N 21/8456; G06V 20/46

(57) ABSTRACT

A method and apparatus of extracting a hot clip in a video, an electronic device, and a computer-readable storage medium are provided. The method includes: acquiring a video to be processed; filtering image frames with repeated content in the video to be processed, so as to obtain a simplified clip of the video to be processed; scoring each image frame in the simplified clip according to user viewing information associated with the video to be processed; and stitching image frames with scores meeting a preset condition sequentially to obtain a stitching result, and determining the stitching result as a hot clip of the video to be processed.

### CROSS REFERENCE TO RELATED APPLICATION(S)

The present disclosure is a Section 371 National Stage Application of International Application No. PCT/CN2020/133034, filed on Dec. 1, 2020, and the PCT Application claims priority to Chinese patent Application No. 2020101086838 entitled “METHOD AND APPARATUS OF EXTRACTING HOT CLIP IN VIDEO”, filed on Feb. 21, 2020, the contents of which are incorporated herein by reference in its entirety.

### TECHNICAL FIELD

The present disclosure relates to a field of Internet technology, and in particular to a method and apparatus of extracting a hot clip in a video, an electronic device, and a computer-readable storage medium, in the multimedia processing technology.

### BACKGROUND

With development of Internet technology, videos in network are present in increasingly diversified forms, and acquisition of wonderful or important content in a video has increasingly become a core demand of users.

Users generally perform multiple speed play, skip play, and other operations to quickly watch videos. However, multiple speed play has a poor audio experience, and skip play is not easy to control a progress so that it is easy to miss some content in a case of much skip progress, or to watch repeated content in a case of too little skip progress.

### SUMMARY

The present disclosure provides a method of extracting a hot clip in a video, including: acquiring a video to be processed; filtering image frames with repeated content in the video to be processed, so as to obtain a simplified clip of the video to be processed; scoring each image frame in the simplified clip according to user viewing information associated with the video to be processed; and stitching image frames with scores meeting a preset condition sequentially to obtain a stitching result, and determining the stitching result as a hot clip of the video to be processed.

According to the embodiments of the present disclosure, the filtering image frames with repeated content in the video to be processed includes: acquiring a video image sequence of the video to be processed; calculating a content repetitive rate between image frames in the video image sequence; determining whether the content repetitive rate exceeds a first threshold or not; retaining, in response to determining that the content repetitive rate exceeds the first threshold, one of repetitive image frames in the video image sequence and filtering out the other image frames in the repetitive image frames; and retaining, in response to determining that the content repetitive rate does not exceed the first threshold, the image frames in the video image sequence.

According to the embodiments of the present disclosure, the user viewing information associated with the video to be processed contains at least one of: a number of times each image frame in the video to be processed is marked by a user, and a number of times each image frame in the video to be processed is validly viewed by the user.

According to the embodiments of the present disclosure, the scoring each image frame in the simplified clip according to user viewing information associated with the video to be processed includes: acquiring a first weight of each image frame being marked and a second weight of each image frame being validly viewed; obtaining a first score of each image frame according to the number of times each image frame is marked and the first weight, and obtaining a second score of each image frame according to the number of times each image frame is validly viewed and the second weight; and adding the first score and the second score, and determining a sum of the first score and the second score as a score of each image frame.

According to the embodiments of the present disclosure, the acquiring the number of times each image frame in the video to be processed is marked by the user includes: providing a mark button in a process of playing the video to be processed; and counting a number of times the mark button is triggered for each image frame in the process of playing the video to be processed, as the number of times each image frame in the video to be processed is marked by the user.

According to the embodiments of the present disclosure, the acquiring the number of times each image frame in the video to be processed is validly viewed by the user includes: determining a playing speed for each image frame in the process of playing the video to be processed; and counting a number of times each image frame in the video to be processed is played at a normal speed, as the number of times each image frame in the video to be processed is validly viewed by the user.

According to the embodiments of the present disclosure, the method further includes: displaying the video to be processed and the hot clip of the video to be processed to allow the user to select for watching.

The present disclosure provides an apparatus of extracting a hot clip in a video, including: an acquisition unit configured to acquire a video to be processed; a simplification unit configured to filter image frames with repeated content in the video to be processed, so as to obtain a simplified clip of the video to be processed; a scoring unit configured to score each image frame in the simplified clip according to user viewing information associated with the video to be processed; and a processing unit configured to stitch image frames with scores meeting a preset condition sequentially to obtain a stitching result, and determine the stitching result as a hot clip of the video to be processed.

According to the embodiments of the present disclosure, the simplification unit, in the filtering image frames with repeated content in the video to be processed, is configured to: acquire a video image sequence of the video to be processed; calculate a content repetitive rate between image frames in the video image sequence; determine whether the content repetitive rate exceeds a first threshold or not; retain, in response to determining that the content repetitive rate exceeds the first threshold, one of repetitive image frames in the video image sequence and filter out the other image frames in the repetitive image frames; and retain, in response to determining that the content repetitive rate does not exceed the first threshold, the image frames in the video image sequence.

According to the embodiments of the present disclosure, for the scoring unit, the user viewing information associated with the video to be processed contains at least one of: a number of times each image frame in the video to be processed is marked by a user, and a number of times each image frame in the video to be processed is validly viewed by the user.

According to the embodiments of the present disclosure, the scoring unit, in the scoring each image frame in the simplified clip according to user viewing information associated with the video to be processed, is configured to: acquire a first weight of each image frame being marked and a second weight of each image frame being validly viewed; obtain a first score of each image frame according to the number of times each image frame is marked and the first weight, and obtain a second score of each image frame according to the number of times each image frame is validly viewed and the second weight; and add the first score and the second score, and determine a sum of the first score and the second score as a score of each image frame.

According to the embodiments of the present disclosure, the scoring unit, in the acquiring the number of times each image frame in the video to be processed is marked by the user, is configured to: provide a mark button in a process of playing the video to be processed; and count a number of times the mark button is triggered for each image frame in the process of playing the video to be processed, as the number of times each image frame in the video to be processed is marked by the user.

According to the embodiments of the present disclosure, the scoring unit, in the acquiring the number of times each image frame in the video to be processed is validly viewed by the user, is configured to: determine a playing speed for each image frame in the process of playing the video to be processed; and count a number of times each image frame in the video to be processed is played at a normal speed, as the number of times each image frame in the video to be processed is validly viewed by the user.

According to the embodiments of the present disclosure, the processing unit is further configured to: display the video to be processed and the hot clip of the video to be processed to allow the user to select for watching.

### BRIEF DESCRIPTION OF THE DRAWINGS

The drawings are used to better understand the present disclosure and do not constitute a limitation to the present disclosure, in which:

FIG. 1 shows a flowchart of a method of extracting a hot clip in a video according to a first embodiment of the present disclosure;

FIG. 2 shows a structural diagram of an apparatus of extracting a hot clip in a video according to a second embodiment of the present disclosure; and

FIG. 3 shows a block diagram of an electronic device for implementing the method of extracting the hot clip in the video according to the embodiments of the present disclosure.

### DETAILED DESCRIPTION OF EMBODIMENTS

The exemplary embodiments of the present disclosure are described below with reference to the drawings, which include various details of the embodiments of the present disclosure to facilitate understanding, and which should be considered as merely illustrative. Therefore, those ordinary skilled in the art should realize that various changes and modifications may be made to the embodiments described herein without departing from the scope and spirit of the present disclosure. In addition, for clarity and conciseness, descriptions of well-known functions and structures are omitted in the following description.

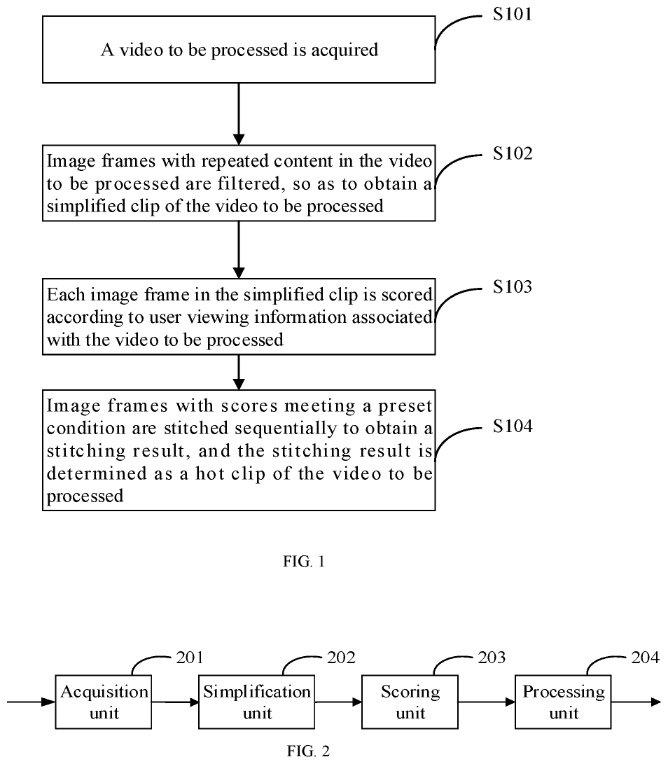

FIG. 1 shows a flowchart of a method of extracting a hot clip in a video according to the embodiments of the present disclosure. As shown in FIG. 1, the method includes following steps.

In step S101, a video to be processed is acquired.

The video to be processed acquired in this step may be an ordinary video, such as TV series, variety show, film and the like, or may be a short video.

It may be understood that in this step, after the video to be processed is acquired, a video image sequence of the video to be processed (that is, a sequence of image frames in the video to be processed) may be further acquired. The video image sequence may be acquired by using various methods, and detailed descriptions will be omitted to avoid redundancy.

In step S102, image frames with repeated content in the video to be processed are filtered, so as to obtain a simplified clip of the video to be processed.

In this step, after the image frames with repeated content in the video to be processed acquired in step S101 are filtered, stitching remaining image frames that are not filtered out to obtain a stitching result, and the stitching result is determined as a simplified clip of the video to be processed. That is, in this step, repetitive image frames in the video may be simplified, so as to optimize a size of the video, and reduce a waste of user memory resources and bandwidth.

For example, in this step, the filtering image frames with repeated content in the video to be processed may include: acquiring a video image sequence of the video to be processed; calculating a content repetitive rate between image frames in the video image sequence, for example, calculating sequentially from an image frame at the beginning of the video to an image frame at the end of the video, and a content repetitive rate between two or more adjacent image frames in the video image sequence acquired; determining whether the content repetitive rate exceeds a first threshold or not; retaining, in response to determining that the content repetitive rate exceeds the first threshold, one of repetitive image frames in the video image sequence and filtering out the other image frames in the repetitive image frames; and retaining, in response to determining that the content repetitive rate does not exceed the first threshold, the image frames in the video image sequence. With this step, the image frames may be filtered more accurately.

In this step, a pre-trained depth learning model may be used for calculating the content repetitive rate between the image frames. That is, each frame image is taken as an input of the depth learning model, and an output result of the depth learning model is taken as the content repetitive rate between the image frames.

In addition, in this step, the content repetitive rate between the image frames may also be calculated by using pixel information in the image frames, such as an average gray value of pixels in the image frame, a hash value of the pixels in the image frame, and so on. Detailed descriptions will be omitted to avoid redundancy.

It may be understand that in this step, the filtering image frames with repeated content in the video to be processed may include: inputting a video image sequence of the video to be processed into a pre-trained image filtering model that may filter the image frames with repeated content in the video image sequence, and obtaining the simplified clip of the video to be processed according to an output result of the image filtering model.

In this step, after the image frames with repeated content in the video to be processed are filtered, the remaining image frames have different contents. The remaining image frames are stitched sequentially to obtain a stitching result, and the stitching result is determined as a corresponding simplified clip of the video to be processed.

In step S103, each image frame in the simplified clip is scored according to user viewing information associated with the video to be processed.

In this step, the user viewing information associated with the video to be processed acquired in step S101 is firstly acquired, and then each image frame in the simplified clip obtained in step S102 is scored according to the acquired user viewing information, so as to determine a scoring result of each image frame in the simplified clip.

For example, in this step, the user viewing information associated with the video to be processed is acquired by counting viewing behaviors of all users viewing the video to be processed. The user viewing information includes at least one of a number of times each image frame in the video to be processed is marked by a user and a number of times each image frame in the video to be processed is validly viewed by the user. With this step, types of the user viewing information may be enriched, so that a scoring result of the image frame may be determined more accurately.

The number of times each image frame in the video to be processed marked by the user indicates a number of times an image frame containing important or wonderful content marked by the user when the user is watching the video to be processed. The more times the image frame is marked, the more important or wonderful the content of the image frame.

For example, in this step, the acquiring the number of times each image frame in the video to be processed is marked by the user may include: providing a mark button that may be manually triggered by the user or may be triggered by user's voice, in a process of playing the video to be processed; and counting a number of times the mark button is triggered for each image frame in the process of playing the video to be processed, as the number of times each image frame in the video to be processed is marked by the user.

The number of times each image frame in the video to be processed is validly viewed by the user indicates a number of times an image frame is played at a normal speed without fast forward, multiple speed play, skip play, etc. when the user is watching the video to be processed. The more times the image frame is validly viewed, the more important or wonderful the content of the image frame.

For example, in this step, the acquiring the number of times each image frame in the video to be processed is validly viewed by the user may include: determining a playing speed for each image frame in the process of playing the video to be processed; and counting a number of times each image frame in the video to be processed is played at a normal speed, as the number of times each image frame in the video to be processed is validly viewed by the user.

The user viewing information acquired in this step reflects importance or brilliance of each image frame in the video to be processed, and each image frame in the simplified clip is scored according to the user viewing information. In this way, the scoring result obtained in this step may indicate the importance or brilliance of different image frames.

For example, in this step, the scoring each image frame in the simplified clip according to user viewing information associated with the video to be processed may include: acquiring a first weight of each image frame being marked and a second weight of each image frame being validly viewed, in which the first weight and the second weight are preset; obtaining a first score of each image frame according to the number of times each image frame is marked and the first weight, and obtaining a second score of each image frame according to the number of times each image frame is validly viewed and the second weight; adding the first score and the second score, and determining a sum of the first score and the second score as a score of each image frame. With this step, the image frame is scored by using multi-dimensional information, so that the scoring result may be determined more accurately.

For example, in a case that the first weight is preset to 1 and the second weight is preset to 0.8, if the number of times an image frame is marked is 100 and the number of times the image frame is validly viewed is 200, then the scoring result of the image frame is determined to: (100*1)+(200*0.8)=260.

In step S104, image frames with scores meeting a preset condition are stitched sequentially to obtain a stitching result, and the stitching result is determined as a hot clip of the video to be processed.

In this step, after the scoring result for each image frame in the simplified clip is obtained in step S103, the image frames with scores meeting the preset condition are selected from the image frames of the simplified clip, and are then stitched sequentially to obtain the stitching result that is determined as the hot clip of the video to be processed. That is, after a first optimization of the video to be processed is performed in step S102, a second optimization is performed in this step on the basis of a result of the first optimization, so that the hot clip does not contain redundant and repeated image frames. In this way, the hot clip of the video to be processed may be obtained more accurately.

In this step, image frames with scores greater than a second threshold may be selected as the image frames meeting the preset condition. Alternatively, the image frames may be sorted according to scores from high to low, and top N image frames may be selected, where N is a positive integer greater than or equal to 1.

It may be understand that in this step, after the hot clip of the video to be processed is obtained, the video to be processed and the corresponding hot clip may be together displayed to the user, so that the user may more flexibly select the corresponding version for watching according to the actual needs. This step may improve a flexibility of video display and provide the user with more viewing options.

Therefore, in the present disclosure, two optimization processes are performed to extract the hot clip of the video to be processed, which may enable the user to watch wonderful content in the video more accurately and conveniently, and may also effectively reduce a size of the hot clip so that a waste of user memory resources and bandwidth may be reduced.

FIG. 2 shows a structural diagram of an apparatus of extracting a hot clip in a video according to the embodiments of the present disclosure. As shown in FIG. 2, the apparatus includes an acquisition unit 201, a simplification unit 202, a scoring unit 203 and a processing unit 204.

The acquisition unit 201 is used to acquire a video to be processed.

The video to be processed acquired by the acquisition unit 201 may be an ordinary video, such as TV series, variety show, film and the like, or may be a short video.

It may be understood that after acquiring the video to be processed, the acquisition unit 201 may further acquire a video image sequence of the video to be processed (that is, a sequence of image frames in the video to be processed). The video image sequence may be acquired by using various methods, and detailed descriptions will be omitted to avoid redundancy.

The simplification unit 202 is used to filter image frames with repeated content in the video to be processed, so as to obtain a simplified clip of the video to be processed.

After filtering the image frames with repeated content in the video to be processed acquired by the acquisition unit 201, the simplification unit 202 may stitch remaining image frames that are not filtered out to obtain a stitching result, and determine the stitching result as a simplified clip of the video to be processed. That is, the simplification unit 202 may simplify repetitive image frames in the video, so as to optimize the size of the video and reduce the waste of user memory resources and bandwidth.

For example, in the filtering the image frames with repeated content in the video to be processed, the simplification unit 202 may perform following operations: acquiring a video image sequence of the video to be processed; calculating a content repetitive rate between image frames in the video image sequence, for example, calculating sequentially from an image frame at the beginning of the video to an image frame at the end of the video, the content repetitive rate between two or more adjacent image frames in the video image sequence; determining whether the content repetitive rate exceeds a first threshold or not; retaining, in response to determining that the content repetitive rate exceeds the first threshold, one of repetitive image frames in the video image sequence and filtering out the other image frames in the repetitive image frames; and retaining, in response to determining that the content repetitive rate does not exceed the first threshold, the image frames in the video image sequence.

When the content repetitive rate between the image frames is calculated by the simplification unit 202, a pre-trained depth learning model may be used for calculation. That is, each frame image is taken as an input of the depth learning model, and an output result of the depth learning model is taken as the content repetitive rate between the image frames.

In addition, the simplification unit 202 may also calculate the content repetitive rate between the image frames by using pixel information in the image frames, such as an average gray value of pixels in the image frame, a hash value of the pixels in the image frame, and so on. Detailed descriptions will be omitted to avoid redundancy.

It may be understand that in the filtering the image frames with repeated content in the video to be processed, the simplification unit 202 may also perform following operations: inputting a video image sequence of the video to be processed into a pre-trained image filtering model that may filter the image frames with repeated content in the video image sequence, and determining the simplified clip of the video to be processed according to an output result of the image filtering model.

After the image frames with repeated content in the video to be processed are filtered by the simplification unit 202, the remaining image frames have different contents. The remaining image frames may be stitched sequentially to obtain a stitching result, and the stitching result obtained may be determined as a corresponding simplified clip of the video to be processed.

The scoring unit 203 is used to score each image frame in the simplified clip according to user viewing information associated with the video to be processed.

The scoring unit 203 may firstly acquire the user viewing information associated with the video to be processed, and then score, according to the acquired user viewing information, each image frame in the simplified clip obtained by the simplification unit 202, so as to determine a scoring result of each image frame in the simplified clip.

For example, the user viewing information associated with the video to be processed is acquired by the scoring unit 203 by counting viewing behaviors of all users viewing the video to be processed. The user viewing information contains at least one of a number of times each image frame in the video to be processed is marked by a user and a number of times each image frame in the video to be processed is validly viewed by the user.

The number of times each image frame in the video to be processed is marked by the user indicates a number of times an image frame containing important or wonderful content is marked by the user when the user is watching the video to be processed. The more times the image frame is marked, the more important or wonderful the content of the image frame.

For example, in the acquiring the number of times each image frame in the video to be processed is marked by the user, the scoring unit 203 may perform following operations: providing a mark button which may be manually triggered by the user or may be triggered by user's voice, in a process of playing the video to be processed; counting a number of times the mark button is triggered for each image frame in the process of playing the video to be processed, as the number of times each image frame in the video to be processed is marked by the user.

The number of times each image frame in the video to be processed is validly viewed by the user indicates a number of times an image frame is played at a normal speed without fast forward, multiple speed play, skip play, etc. when the user is watching the video to be processed. The more times the image frame is validly viewed, the more important or wonderful the content of the image frame.

For example, in the acquiring the number of times each image frame in the video to be processed is validly viewed by the user, the scoring unit 203 may perform following operations: determining a playing speed for each image frame in the process of playing the video to be processed; and counting a number of times each image frame in the video to be processed is played at a normal speed, as the number of times each image frame in the video to be processed is validly viewed by the user.

The user viewing information acquired by the scoring unit 203 reflects importance or brilliance of each image frame in the video to be processed, and each image frame in the simplified clip is scored by the scoring unit 203 according to the user viewing information. In this way, the scoring result obtained may indicate the importance or brilliance of different image frames.

For example, in the scoring each image frame in the simplified clip according to user viewing information associated with the video to be processed, the scoring unit 203 may perform following operations: acquiring a first weight of each image frame being marked and a second weight of each image frame being validly viewed, wherein the first weight and the second weight are preset; obtaining a first score of each image frame according to the number of times each image frame is marked and the first weight, and obtaining a second score of each image frame according to the number of times each image frame is validly viewed and the second weight; adding the first score and the second score, and determining a sum of the first score and the second score as a score of each image frame.

The processing unit 204 is used to stitch image frames with scores meeting a preset condition sequentially to obtain a stitching result, and determine the stitching result as a hot clip of the video to be processed.

After the scoring result of each image frame in the simplified clip is obtained by the scoring unit 203, the processing unit 204 may select the image frames with scores meeting the preset condition from the image frames of the simplified clip, then stitch the selected image frames sequentially to obtain the stitching result, and determine the stitching result as the hot clip of the video to be processed.

That is to say, after a first optimization of the video to be processed is performed by the simplification unit 202, the processing unit 204 may perform a second optimization on the basis of a result of the first optimization, so that the hot clip does not contain redundant and repeated image frames. In this way, the hot clip of the video to be processed may be obtained more accurately.

The processing unit 204 may select image frames with scores greater than a second threshold as the image frames meeting the preset condition. Alternatively, the image frames may be sorted according to scores from high to low, and top N image frames may be selected, where N is a positive integer greater than or equal to 1.

It may be understand that after obtaining the hot clip of the video to be processed, the processing unit 204 may display the video to be processed and the corresponding hot clip together to the user, so that the user may more flexibly select the corresponding version for watching according to the actual needs.

The embodiments in the present disclosure have following advantages or beneficial effects. The present disclosure may improve the accuracy of extracting the hot clip so as to enable the user to watch wonderful content in the video more accurately and conveniently, and may also effectively reduce the size of the hot clip so as to reduce a waste of user memory resources and bandwidth. Because the hot clip in the video is extracted by two optimization processes, the technical problem in a related art that the user can not accurately watch the wonderful content in a case of multiple speed play or skip play may be solved. The accuracy of extracting the hot clip may be improved, and the size of the hot clip may be reduced, so that the waste of user memory resources and bandwidth may be reduced.

According to the embodiments of the present disclosure, the present disclosure further provides an electronic device and a computer-readable storage medium.

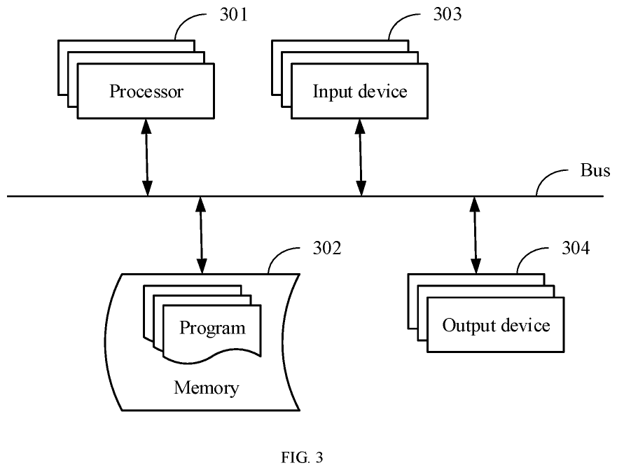

FIG. 3 shows a block diagram of an electronic device for implementing the method of extracting the hot clip of the video according to the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 3, the electronic device may include one or more processors 301, a memory 302, and interface(s) for connecting various components, including high-speed interface(s) and low-speed interface(s). The various components are connected to each other by using different buses, and may be installed on a common motherboard or installed in other manners as required. The processor may process instructions executed in the electronic device, including instructions stored in or on the memory to display graphical information of GUI (Graphical User Interface) on an external input/output device (such as a display device coupled to an interface). In other embodiments, a plurality of processors and/or a plurality of buses may be used with a plurality of memories, if necessary. Similarly, a plurality of electronic devices may be connected in such a manner that each apparatus providing a part of necessary operations (for example, as a server array, a group of blade servers, or a multi-processor system). In FIG. 3, a processor 301 is illustrated by way of example.

The memory 302 is a non-transitory computer-readable storage medium provided by the present disclosure. The memory stores instructions executable by at least one processor, to cause the at least one processor to perform the method of extracting the hot clip in the video provided in the present disclosure. The non-transitory computer-readable storage medium of the present disclosure stores computer instructions for allowing a computer to perform the method of extracting the hot clip in the video provided in the present disclosure.

The memory 302, as a non-transitory computer-readable storage medium, may be used to store non-transitory software programs, non-transitory computer-executable programs and modules, such as program instructions/modules corresponding to the method of extracting the hot clip in the video in the embodiments of the present disclosure (for example, the acquisition unit 201, the simplification unit 202, the scoring unit 203 and the processing unit 204 shown in FIG. 2). The processor 301 executes various functional applications and data processing of the server by executing the non-transient software programs, instructions and modules stored in the memory 302, thereby implementing the method of extracting the hot clip in the video in the embodiments of the method mentioned above.

The memory 302 may include a program storage area and a data storage area. The program storage area may store an operating system and an application program required by at least one function. The data storage area may store data etc. generated by using the electronic device. In addition, the memory 302 may include a high-speed random access memory, and may further include a non-transitory memory, such as at least one magnetic disk storage device, a flash memory device, or other non-transitory solid-state storage devices. In some embodiments, the memory 302 may include a memory provided remotely with respect to the processor 301, and such remote memory may be connected through a network to the electronic device for the method of extracting the hot clip in the video. Examples of the above-mentioned network include, but are not limited to the Internet, intranet, local area network, mobile communication network, and combination thereof.

The electronic device for the method of extracting the hot clip in the video may further include an input device 303 and an output device 304. The processor 301, the memory 302, the input device 303 and the output device 304 may be connected by a bus or in other manners. In FIG. 3, the connection by a bus is illustrated by way of example.

The input device 303 may receive input information of numbers or character, and generate key input signals related to user settings and function control of the electronic device for the method of extracting the hot clip in the video, such as a touch screen, a keypad, a mouse, a track pad, a touchpad, a pointing stick, one or more mouse buttons, a trackball, a joystick, and so on. The output device 304 may include a display device, an auxiliary lighting device (for example, LED), a tactile feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in a digital electronic circuit system, an integrated circuit system, an application specific integrated circuit (ASIC), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

These computing programs (also referred as programs, software, software applications, or codes) include machine instructions for a programmable processor, and may be implemented using high-level programming languages, object-oriented programming languages, and/or assembly/machine languages. As used herein, the terms “machine-readable medium” and “computer-readable medium” refer to any computer program product, apparatus and/or device (for example, magnetic disk, optical disk, memory, programmable logic device (PLD)) for providing machine instructions and/or data to a programmable processor, including a machine-readable medium for receiving machine instructions as machine-readable signals. The term “machine-readable signal” refers to any signal for providing machine instructions and/or data to a programmable processor.

In order to provide interaction with the user, the systems and technologies described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other.

In the technical solutions according to the embodiments of the present disclosure, two optimization processes are performed to extract the hot clip of the video to be processed, which may improve accuracy of extracting the hot clip so that the user may watch wonderful content in the video more accurately and conveniently, and which may effectively reduce the size of the hot clip extracted so that the waste of user memory resources and bandwidth may be reduced.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the protection scope of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of extracting a hot clip in a video, comprising:
acquiring a video to be processed;
filtering image frames with repeated content in the video to be processed, so as to obtain a simplified clip of the video to be processed;
scoring each image frame in the simplified clip according to user viewing information associated with the video to be processed; and
stitching image frames with scores meeting a preset condition sequentially to obtain a stitching result, and determining the stitching result as a hot clip of the video to be processed.

2. The method of claim 1, wherein the filtering image frames with repeated content in the video to be processed comprises:
acquiring a video image sequence of the video to be processed;
calculating a content repetitive rate between image frames in the video image sequence;
determining whether the content repetitive rate exceeds a first threshold or not;
retaining, in response to determining that the content repetitive rate exceeds the first threshold, one of repetitive image frames in the video image sequence and filtering out the other image frames in the repetitive image frames; and
retaining, in response to determining that the content repetitive rate does not exceed the first threshold, the image frames in the video image sequence.

3. The method of claim 1, wherein the user viewing information associated with the video to be processed contains at least one of: a number of times each image frame in the video to be processed is marked by a user, and a number of times each image frame in the video to be processed is validly viewed by the user.

4. The method of claim 3, wherein the scoring each image frame in the simplified clip according to user viewing information associated with the video to be processed comprises:
acquiring a first weight of each image frame being marked and a second weight of each image frame being validly viewed;
obtaining a first score of each image frame according to the number of times each image frame is marked and the first weight, and obtaining a second score of each image frame according to the number of times each image frame is validly viewed and the second weight; and
adding the first score and the second score, and determining a sum of the first score and the second score as a score of each image frame.

5. The method of claim 3, wherein the acquiring the number of times each image frame in the video to be processed is marked by the user comprises:
providing a mark button in a process of playing the video to be processed; and
counting a number of times the mark button is triggered for each image frame in the process of playing the video to be processed, as the number of times each image frame in the video to be processed is marked by the user.

6. The method of claim 3, wherein the acquiring the number of times each image frame in the video to be processed is validly viewed by the user comprises:
determining a playing speed for each image frame in the process of playing the video to be processed; and
counting a number of times each image frame in the video to be processed is played at a normal speed, as the number of times each image frame in the video to be processed is validly viewed by the user.

7. The method of claim 1, further comprising:
displaying the video to be processed and the hot clip of the video to be processed to allow the user to select for watching.

8-14. (canceled)

15. An electronic device, comprising:
at least one processor; and
a memory communicatively connected to the at least one processor, wherein the memory stores instructions executable by the at least one processor, and the instructions, when executed by the at least one processor, cause the at least one processor to implement a method of extracting a hot clip in a video, and the method comprises:
acquiring a video to be processed;
filtering image frames with repeated content in the video to be processed, so as to obtain a simplified clip of the video to be processed;
scoring each image frame in the simplified clip according to user viewing information associated with the video to be processed; and
stitching image frames with scores meeting a preset condition sequentially to obtain a stitching result, and determining the stitching result as a hot clip of the video to be processed.

16. A non-transitory computer-readable storage medium having computer instructions stored thereon, wherein the computer instructions allow a computer to implement a method of extracting a hot clip in a video, and the method comprises:
acquiring a video to be processed;
filtering image frames with repeated content in the video to be processed, so as to obtain a simplified clip of the video to be processed;
scoring each image frame in the simplified clip according to user viewing information associated with the video to be processed; and
stitching image frames with scores meeting a preset condition sequentially to obtain a stitching result, and determining the stitching result as a hot clip of the video to be processed.
